(19) United States
(12) Patent Application Publication
(10) Pub. No.: US 2025/0374922 A1
(43) Pub. Date: Dec. 11, 2025

(54) METHOD FOR PREPARING ANTIBACTERIAL PBAT FOAMED MATERIAL

(71) Applicant: Fujian Kaiji Polymer Materials Co., Ltd., Quanzhou City (CN)

(72) Inventor: Wenjun Zhang, Quanzhou City (CN)

(21) Appl. No.: 18/983,996

(22) Filed: Dec. 17, 2024

(30) Foreign Application Priority Data
Jun. 5, 2024 (CN) 202410718171.1

(51) Int. Cl. A01N 37/12; A01P 1/00; C08L 5/08; C08L 67/06

(52) U.S. Cl. CPC A01N 37/12; C08L 5/08; C08L 67/06; A01P 1/00; C08L 2203/14

(57) ABSTRACT

A method for preparing an antibacterial PBAT foamed material, including: Step A1-A3. Step A1: mixing 5,5-bis(hydroxymethyl)-2-phenyl-1,3-dioxane, sodium hydroxide, and DMF; stirring and adding 3-bromo-1-propene for reaction to obtain intermediate 1; mixing the intermediate 1 with a hydrochloric acid solution and DMF for reaction to obtain intermediate 2. Step A2: mixing the intermediate 2, 2-methacryloxyethyltrimethylammonium chloride, hexafluorobutyl methacrylate, and DMF; stirring and adding ammonium persulfate for reaction to obtain a modified monomer; mixing the modified monomer, terephthalic acid, adipic acid, 1,4-butanediol, tetrabutyl titanate, antimony trioxide, and N-methylpyrrolidone for reaction; raising temperature for reaction to obtain a modified copolymer. Step A3: melting and kneading the modified copolymer, a modified filler, and azodicarbonamide; foaming under a stabilized pressure; cooling to room temperature, soaking in a treatment solution under a stabilized temperature to obtain a resultant; taking out the resultant and drying to obtain the antibacterial PBAT foamed material.

### CROSS REFERENCE

The present disclosure claims priority of Chinese Patent Applications No. 202410718171.1 filed on Jun. 5, 2024, the entire contents of which are hereby incorporated by reference in their entirety.

### TECHNICAL FIELD

The present disclosure relates to the technical field of preparation of antibacterial foamed materials, and more specifically to a method for preparing an antibacterial PBAT foamed material.

### BACKGROUND

PBAT is a biodegradable material with broad development prospects. The molecular structure of PBAT has both flexible fatty chain segments and rigid aromatic chain segments. The fatty chain segments make the molecule flexible and degradable, while the aromatic chain segments ensure good mechanical properties. Due to its excellent properties, PBAT is widely applied in the processing of polymer materials and can be specifically applied in different fields such as extrusion, injection molding, and blown film processing. Due to its close properties to LDPE, PBAT has the potential to replace LDPE, so as to obtain broad market prospects in different industries such as the medical industry, agriculture, and the packaging industry. Foamed materials refer to materials with a resin matrix that contain a large number of pores inside and can be regarded as composite materials with gas as the filler. Due to the biodegradability of PBAT, the bacteria in the pores of PBAT foamed materials will affect the mechanical properties of the material itself. Therefore, it is required to empower the PBT foamed materials with antibacterial function to prevent the above issue.

### SUMMARY OF THE DISCLOSURE

The purpose of the present disclosure is to provide a method for preparing an antibacterial PBAT foamed material, for solving the problem that the conventional PBAT foamed material is prone to bacterial growth in the pores.

The purpose of the present disclosure can be achieved by the following technical solutions.

A method for preparing an antibacterial PBAT foamed material, including the following steps:
Step A1: mixing 5,5-bis(hydroxymethyl)-2-phenyl-1,3-dioxane, sodium hydroxide, and DMF; stirring and adding 3-bromo-1-propene at 120-150 r/min and 20-25° C. for reaction for 20-25 h to obtain intermediate 1; mixing the intermediate 1 with a hydrochloric acid solution and DMF for reaction at 200-300 r/min and 40-50° C. for 3-5 h to obtain intermediate 2.
Step A2: mixing the intermediate 2, 2-methacryloxyethyltrimethylammonium chloride, hexafluorobutyl methacrylate, and DMF until uniform; stirring and adding ammonium persulfate at 60-80 r/min and 75-80° C. for reaction for 6-8 h to obtain a modified monomer; mixing the modified monomer, methylpyrrolidone until uniform for reaction at 160-180° C. for 2-3 h; raising temperature to 240-255° C. for reaction under a pressure of 40-45 Pa for 2-3 h to obtain a modified copolymer.
Step A3: mixing the modified copolymer, a modified filler, and azodicarbonamide until uniform; melting and kneading at 140-145° C. for 8-10 minutes; foaming at 200-205° C. under a pressure of 3-3.5 MPa for 30 seconds; cooling to room temperature, soaking in a treatment solution under a temperature of 150-155° C. for 8-10 h to obtain a resultant; taking out the resultant and drying to obtain the antibacterial PBAT foamed material.

In step A1, the amount ratio of 5,5-bis(hydroxymethyl)-2-phenyl-1,3-dioxane, sodium hydroxide, 3-bromo-1-propene, and DMF is 1 mmol: 1.1 mmol: 1 mmol: 10 mL, the amount ratio of the intermediate 1, hydrochloric acid solution, and DMF is 2 mmol: 3 mL: 10 mL, and the mass fraction of the hydrochloric acid solution is 3.65%.

In step A2, the amount ratio of the intermediate 2, 2-methacryloxyethyltrimethylammonium chloride, hexafluorobutyl methacrylate, and DMF is 2.5 g: 13.8 g: 18.2 g: 100 mL, the amount of ammonium persulfate is 0.5% by mass of the mass sum of the intermediate 2, 2-methacryloxyethyltrimethylammonium chloride, and hexafluorobutyl methacrylate, the amount ratio of the modified monomer, terephthalic acid, adipic acid, 1,4-butanediol, and N-methylpyrrolidone is 157 g: 996 g: 584 g: 900 g: 10 L, the amount of tetrabutyl titanate is 0.05% by mass of the mass sum of the modified monomer, terephthalic acid, adipic acid, and 1,4-butanediol, and the amount of antimony trioxide is 0.02% by mass of the mass sum of the modified monomer, terephthalic acid, adipic acid, and 1,4-butanediol.

In step A3, the mass ratio of the modified copolymer, modified filler, and azodicarbonamide is (80-100):(3-5):(2-3), and the treatment solution is a 0.1 mmol/L solution of ruthenium dichloride in ethanol. The modified filler is prepared according to the following steps:
Step B1: mixing p-bromobenzaldehyde, 1,10-phenanthroline-5,6-dione, ammonium acetate, and acetic acid until uniform for reaction at 120-150 r/min and 130-140° C. for 3-5 h; lowering temperature to 20-25° C., and adding ammonia water to neutralize to obtain intermediate 3; mixing triisopropyl borate, n-butyllithium, and tetrahydrofuran until uniform, and stirring and adding the intermediate 3 at 120-150 r/min and −78° C. for reaction for 5-7 h to obtain a modifier.
Step B2: dissolving chitosan in a hydrochloric acid solution, adding caffeic acid, deionized water, and anhydrous ethanol; stirring and adding 1-ethyl-3-(3-dimethylaminopropyl) carbodiimide at 150-200 r/min and 25-30° C. for reaction for 10-15 h to obtain pre-treated chitosan; mixing the pre-treated chitosan, the modifier, and DMF until uniform, and stirring and adding tetramethylammonium hydroxide at 120-150 r/min and 60-70° C. until pH reaches 7.5-8; leaving for reaction for 10-15 h to obtain the modified filler.

In step B1, the amount ratio of p-bromobenzaldehyde, 1,10-phenanthroline-5,6-dione, ammonium acetate, and acetic acid is 2.5 mmol: 2.5 mmol: 4.8 g: 40 mL, and the amount ratio of triisopropyl borate, n-butyllithium, the intermediate 3, and tetrahydrofuran is 1 mmol: 2 mmol: 2 mmol: 10 mL.

In step B2, the amount ratio of chitosan, the hydrochloric acid solution, caffeic acid, deionized water, anhydrous ethanol, and 1-ethyl-3-(3-dimethylaminopropyl) carbodiimide is 2 g: 200 mL: 15 mmol: 5 mL: 20 mL: 32 mmol, the mass fraction of the hydrochloric acid solution is 1%, and the amount ratio of boric acid group, the modifier and DMF on the pre-treated chitosan is 1 mmol: 1.2 mmol: 10 mL.

Beneficial effects of the present disclosure: An antibacterial PBAT foamed material proposed by the present disclosure is prepared by melt blending a modified copolymer, a modified filler, and azodicarbonamide, followed by pressure-maintaining foaming, and finally treating the foamed material with a treatment solution. The modified copolymer is prepared using 5,5-bis(hydroxymethyl)-2-phenyl-1,3-dioxane and 3-bromo-1-propene as raw materials. Under the action of sodium hydroxide, the hydroxyl group on 5,5-bis(hydroxymethyl)-2-phenyl-1,3-dioxane and the bromine atom on 3-bromo-1-propene react to form intermediate 1. The acetal structure in the intermediate 1 is hydrolyzed under acidic conditions to form intermediate 2. The intermediate 2, 2-methacryloxyethyltrimethylammonium chloride, and hexafluorobutyl methacrylate are polymerized to obtain the modified monomer, and the modified monomer, terephthalic acid, adipic acid, and 1,4-butanediol are esterified and polymerized to obtain the modified copolymer. The modified copolymer contains long-chain fluoroalkanes and quaternary ammonium salt structures. The positively charged quaternary ammonium salt functional groups can attract negatively charged cell membranes, thereby causing the quaternary ammonium salt to be adsorbed on the surface of the bacteria. The hydrophobic long alkyl chain can penetrate the cell membrane, resulting in an uneven distribution of charges on the cell membrane and damage to the integrity of the cell membrane, which causes the leakage of intracellular substances and kills the bacteria. The long-chain fluoroalkanes can reduce the surface energy of PBAT foamed materials, inhibit the adhesion of bacteria and the adsorption of proteins, and thus reduce bacterial growth. The modified filler reacts with p-bromobenzaldehyde and 1,10-phenanthroline-5,6-dione as raw materials to cause the aldehyde group on p-bromobenzaldehyde and the diketone group on 1,10-phenanthroline-5,6-dione react to form an imidazole structure, to obtain intermediate 3. The intermediate 3 is reacted with triisopropyl borate to form a phenylboronic acid structure, and the modifier is obtained. The chitosan and caffeic acid are reacted, causing the carboxyl group on caffeic acid and the carboxyl group on chitosan to undergo dehydration, so as to obtain pre-treated chitosan. The modified filler is produced by reacting the pre-treated chitosan with the modifier so that the bisphenol on the pretreated chitosan and the phenylboronic acid structure on the modifier react to form a borate structure. The modified filler is cationic and is able to adsorb and bind to the negative charge on the bacterial surface, resulting in the loss of the bacterial cell wall. The amino group on the surface can combine with the acidic components on the bacterial surface, thus changing the permeability of the bacterial cell membrane, which leads to the leakage of substances in the bacterial cell. Moreover, when treated with a treatment solution, ruthenium complexes can be formed on the surface, thereby increasing the antimicrobial properties of the PBAT foamed material.

### DETAILED DESCRIPTION

The technical solutions illustrated by the embodiments of the present disclosure will be described clearly and completely below. Obviously, the embodiments described are only a part of the embodiments of the present disclosure, but not all of them. All other embodiments obtained by those skilled in the art without creative effort based on the embodiments of the present disclosure fall within the scope of the present disclosure.
Embodiment 1: A method for preparing an antibacterial PBAT foamed material, including the following steps:
Step A1: mixing 5,5-bis(hydroxymethyl)-2-phenyl-1,3-dioxane, sodium hydroxide, and DMF; stirring and adding 3-bromo-1-propene at 120 r/min and 20° C. for reaction for 20 h to obtain intermediate 1; mixing the intermediate 1 with a hydrochloric acid solution and DMF for reaction at 200 r/min and 40° C. for 3 h to obtain intermediate 2.
Step A2: mixing the intermediate 2, 2-methacryloxyethyltrimethylammonium chloride, hexafluorobutyl methacrylate, and DMF until uniform; stirring and adding ammonium persulfate at 60 r/min and 75° C. for reaction for 6 h to obtain a modified monomer; mixing the modified monomer, terephthalic acid, adipic acid, 1,4-butanediol, tetrabutyl titanate, antimony trioxide, and N-methylpyrrolidone until uniform for reaction at 160° C. for 2 h; raising temperature to 240° C. for reaction under a pressure of 40 Pa for 2 h to obtain a modified copolymer.
Step A3: mixing the modified copolymer, a modified filler, and azodicarbonamide until uniform; melting and kneading at 140° C. for 8 minutes; foaming at 200° C. under a pressure of 3 MPa for 30 seconds; cooling to room temperature, soaking in a treatment solution under a temperature of 150° C. for 8 h to obtain a resultant; taking out the resultant and drying to obtain the antibacterial PBAT foamed material.

In step A1, the amount ratio of 5,5-bis(hydroxymethyl)-2-phenyl-1,3-dioxane, sodium hydroxide, 3-bromo-1-propene, and DMF is 1 mmol: 1.1 mmol: 1 mmol: 10 mL, the amount ratio of the intermediate 1, hydrochloric acid solution, and DMF is 2 mmol: 3 mL: 10 mL, and the mass fraction of the hydrochloric acid solution is 3.65%.

In step A2, the amount ratio of the intermediate 2, 2-methacryloxyethyltrimethylammonium chloride, hexafluorobutyl methacrylate, and DMF is 2.5 g: 13.8 g: 18.2 g: 100 mL, the amount of ammonium persulfate is 0.5% by mass of the mass sum of the intermediate 2, 2-methacryloxyethyltrimethylammonium chloride, and hexafluorobutyl methacrylate, the amount ratio of the modified monomer, terephthalic acid, adipic acid, 1,4-butanediol, and N-methylpyrrolidone is 157 g: 996 g: 584 g: 900 g: 10 L, the amount of tetrabutyl titanate is 0.05% by mass of the mass sum of the modified monomer, terephthalic acid, adipic acid, and 1,4-butanediol, and the amount of antimony trioxide is 0.02% by mass of the mass sum of the modified monomer, terephthalic acid, adipic acid, and 1,4-butanediol.

In step A3, the mass ratio of the modified copolymer, modified filler, and azodicarbonamide is 80:3:2, and the treatment solution is a 0.1 mmol/L solution of ruthenium dichloride in ethanol. The modified filler is prepared according to the following steps:
Step B1: mixing p-bromobenzaldehyde, 1,10-phenanthroline-5,6-dione, ammonium acetate, and acetic acid until uniform for reaction at 120 r/min and 130° C. for 3 h; lowering temperature to 20° C., and adding ammonia water to neutralize to obtain intermediate 3; mixing triisopropyl borate, n-butyllithium, and tetrahydrofuran until uniform, and stirring and adding the intermediate 3 at 120 r/min and −78° C. for reaction for 5 h to obtain a modifier.
Step B2: dissolving chitosan in a hydrochloric acid solution, adding caffeic acid, deionized water, and anhydrous ethanol; stirring and adding 1-ethyl-3-(3-dimethylaminopropyl) carbodiimide at 150 r/min and 25° C. for reaction for 10 h to obtain pre-treated chitosan; mixing the pre-treated chitosan, the modifier, and DMF until uniform, and stirring and adding tetramethylammonium hydroxide at 120 r/min and 60° C. until pH reaches 7.5; leaving for reaction for 10 h to obtain the modified filler.

In step B1, the amount ratio of p-bromobenzaldehyde, 1,10-phenanthroline-5,6-dione, ammonium acetate, and acetic acid is 2.5 mmol: 2.5 mmol: 4.8 g: 40 mL, and the amount ratio of triisopropyl borate, n-butyllithium, the intermediate 3, and tetrahydrofuran is 1 mmol: 2 mmol: 2 mmol: 10 mL.

In step B2, the amount ratio of chitosan, the hydrochloric acid solution, caffeic acid, deionized water, anhydrous ethanol, and 1-ethyl-3-(3-dimethylaminopropyl) carbodiimide is 2 g: 200 mL: 15 mmol: 5 mL: 20 mL: 32 mmol, the mass fraction of the hydrochloric acid solution is 1%, and the amount ratio of boric acid group, the modifier and DMF on the pre-treated chitosan is 1 mmol: 1.2 mmol: 10 mL.
Embodiment 2: A method for preparing an antibacterial PBAT foamed material, including the following steps:
Step A1: mixing 5,5-bis(hydroxymethyl)-2-phenyl-1,3-dioxane, sodium hydroxide, and DMF; stirring and adding 3-bromo-1-propene at 120 r/min and 23° C. for reaction for 23 h to obtain intermediate 1; mixing the intermediate 1 with a hydrochloric acid solution and DMF for reaction at 200 r/min and 45° C. for 4 h to obtain intermediate 2.
Step A2: mixing the intermediate 2, 2-methacryloxyethyltrimethylammonium chloride, hexafluorobutyl methacrylate, and DMF until uniform; stirring and adding ammonium persulfate at 60 r/min and 78° C. for reaction for 7 h to obtain a modified monomer; mixing the modified monomer, terephthalic acid, adipic acid, 1,4-butanediol, tetrabutyl titanate, antimony trioxide, and N-methylpyrrolidone until uniform for reaction at 170° C. for 2.5 h; raising temperature to 250° C. for reaction under a pressure of 45 Pa for 2.5 h to obtain a modified copolymer.
Step A3: mixing the modified copolymer, a modified filler, and azodicarbonamide until uniform; melting and kneading at 140° C. for 9 minutes; foaming at 205° C. under a pressure of 3 MPa for 30 seconds; cooling to room temperature, soaking in a treatment solution under a temperature of 155° C. for 9 h to obtain a resultant; taking out the resultant and drying to obtain the antibacterial PBAT foamed material.

In step A1, the amount ratio of 5,5-bis(hydroxymethyl)-2-phenyl-1,3-dioxane, sodium hydroxide, 3-bromo-1-propene, and DMF is 1 mmol: 1.1 mmol: 1 mmol: 10 mL, the amount ratio of the intermediate 1, hydrochloric acid solution, and DMF is 2 mmol: 3 mL: 10 mL, and the mass fraction of the hydrochloric acid solution is 3.65%.

In step A2, the amount ratio of the intermediate 2, 2-methacryloxyethyltrimethylammonium chloride, hexafluorobutyl methacrylate, and DMF is 2.5 g: 13.8 g: 18.2 g: 100 mL, the amount of ammonium persulfate is 0.5% by mass of the mass sum of the intermediate 2, 2-methacryloxyethyltrimethylammonium chloride, and hexafluorobutyl methacrylate, the amount ratio of the modified monomer, terephthalic acid, adipic acid, 1,4-butanediol, and N-methylpyrrolidone is 157 g: 996 g: 584 g: 900 g: 10 L, the amount of tetrabutyl titanate is 0.05% by mass of the mass sum of the modified monomer, terephthalic acid, adipic acid, and 1,4-butanediol, and the amount of antimony trioxide is 0.02% by mass of the mass sum of the modified monomer, terephthalic acid, adipic acid, and 1,4-butanediol.

In step A3, the mass ratio of the modified copolymer, modified filler, and azodicarbonamide is 90:4:2.5, and the treatment solution is a 0.1 mmol/L solution of ruthenium dichloride in ethanol.

The modified filler is prepared according to the following steps:
Step B1: mixing p-bromobenzaldehyde, 1,10-phenanthroline-5,6-dione, ammonium acetate, and acetic acid until uniform for reaction at 120 r/min and 135° C. for 4 h; lowering temperature to 25° C., and adding ammonia water to neutralize to obtain intermediate 3; mixing triisopropyl borate, n-butyllithium, and tetrahydrofuran until uniform, and stirring and adding the intermediate 3 at 120 r/min and −78° C. for reaction for 6 h to obtain a modifier.
Step B2: dissolving chitosan in a hydrochloric acid solution, adding caffeic acid, deionized water, and anhydrous ethanol; stirring and adding 1-ethyl-3-(3-dimethylaminopropyl) carbodiimide at 150 r/min and 28° C. for reaction for 15 h to obtain pre-treated chitosan; mixing the pre-treated chitosan, the modifier, and DMF until uniform, and stirring and adding tetramethylammonium hydroxide at 120 r/min and 65° C. until pH reaches 7.5; leaving for reaction for 15 h to obtain the modified filler.

In step B1, the amount ratio of p-bromobenzaldehyde, 1,10-phenanthroline-5,6-dione, ammonium acetate, and acetic acid is 2.5 mmol: 2.5 mmol: 4.8 g: 40 mL, and the amount ratio of triisopropyl borate, n-butyllithium, the intermediate 3, and tetrahydrofuran is 1 mmol: 2 mmol: 2 mmol: 10 mL.

In step B2, the amount ratio of chitosan, the hydrochloric acid solution, caffeic acid, deionized water, anhydrous ethanol, and 1-ethyl-3-(3-dimethylaminopropyl) carbodiimide is 2 g: 200 mL: 15 mmol: 5 mL: 20 mL: 32 mmol, the mass fraction of the hydrochloric acid solution is 1%, and the amount ratio of boric acid group, the modifier and DMF on the pre-treated chitosan is 1 mmol: 1.2 mmol: 10 mL.
Embodiment 3: A method for preparing an antibacterial PBAT foamed material, including the following steps:
Step A1: mixing 5,5-bis(hydroxymethyl)-2-phenyl-1,3-dioxane, sodium hydroxide, and DMF; stirring and adding 3-bromo-1-propene at 150 r/min and 25° C. for reaction for 25 h to obtain intermediate 1; mixing the intermediate 1 with a hydrochloric acid solution and DMF for reaction at 300 r/min and 50° C. for 5 h to obtain intermediate 2.
Step A2: mixing the intermediate 2, 2-methacryloxyethyltrimethylammonium chloride, hexafluorobutyl methacrylate, and DMF until uniform; stirring and adding ammonium persulfate at 80 r/min and 80° C. for reaction for 8 h to obtain a modified monomer; mixing the modified monomer, methylpyrrolidone until uniform for reaction at 180° C. for 3 h; raising temperature to 255° C. for reaction under a pressure of 45 Pa for 3 h to obtain a modified copolymer.
Step A3: mixing the modified copolymer, a modified filler, and azodicarbonamide until uniform; melting and kneading at 145° C. for 10 minutes; foaming at 205° C. under a pressure of 3.5 MPa for 30 seconds; cooling to room temperature, soaking in a treatment solution under a temperature of 155° C. for 10 h to obtain a resultant; taking out the resultant and drying to obtain the antibacterial PBAT foamed material.

In step A1, the amount ratio of 5,5-bis(hydroxymethyl)-2-phenyl-1,3-dioxane, sodium hydroxide, 3-bromo-1-propene, and DMF is 1 mmol: 1.1 mmol: 1 mmol: 10 mL, the amount ratio of the intermediate 1, hydrochloric acid solution, and DMF is 2 mmol: 3 mL: 10 mL, and the mass fraction of the hydrochloric acid solution is 3.65%.

In step A2, the amount ratio of the intermediate 2, 2-methacryloxyethyltrimethylammonium chloride, hexafluorobutyl methacrylate, and DMF is 2.5 g: 13.8 g: 18.2 g: 100 mL, the amount of ammonium persulfate is 0.5% by mass of the mass sum of the intermediate 2, 2-methacryloxyethyltrimethylammonium chloride, and hexafluorobutyl methacrylate, the amount ratio of the modified monomer, terephthalic acid, adipic acid, 1,4-butanediol, and N-methylpyrrolidone is 157 g: 996 g: 584 g: 900 g: 10 L, the amount of tetrabutyl titanate is 0.05% by mass of the mass sum of the modified monomer, terephthalic acid, adipic acid, and 1,4-butanediol, and the amount of antimony trioxide is 0.02% by mass of the mass sum of the modified monomer, terephthalic acid, adipic acid, and 1,4-butanediol.

In step A3, the mass ratio of the modified copolymer, modified filler, and azodicarbonamide is 100:5:3, and the treatment solution is a 0.1 mmol/L solution of ruthenium dichloride in ethanol.

The modified filler is prepared according to the following steps:
Step B1: mixing p-bromobenzaldehyde, 1,10-phenanthroline-5,6-dione, ammonium acetate, and acetic acid until uniform for reaction at 150 r/min and 110° C. for 5 h; lowering temperature to 25° C., and adding ammonia water to neutralize to obtain intermediate 3; mixing triisopropyl borate, n-butyllithium, and tetrahydrofuran until uniform, and stirring and adding the intermediate 3 at 150 r/min and −78° C. for reaction for 7 h to obtain a modifier.
Step B2: dissolving chitosan in a hydrochloric acid solution, adding caffeic acid, deionized water, and anhydrous ethanol; stirring and adding 1-ethyl-3-(3-dimethylaminopropyl) carbodiimide at 200 r/min and 30° C. for reaction for 15 h to obtain pre-treated chitosan; mixing the pre-treated chitosan, the modifier, and DMF until uniform, and stirring and adding tetramethylammonium hydroxide at 150 r/min and 70° C. until pH reaches 8; leaving for reaction for 15 h to obtain the modified filler.

In step B1, the amount ratio of p-bromobenzaldehyde, 1,10-phenanthroline-5,6-dione, ammonium acetate, and acetic acid is 2.5 mmol: 2.5 mmol: 4.8 g: 40 mL, and the amount ratio of triisopropyl borate, n-butyllithium, the intermediate 3, and tetrahydrofuran is 1 mmol: 2 mmol: 2 mmol: 10 mL.

In step B2, the amount ratio of chitosan, the hydrochloric acid solution, caffeic acid, deionized water, anhydrous ethanol, and 1-ethyl-3-(3-dimethylaminopropyl) carbodiimide is 2 g: 200 mL: 15 mmol: 5 mL: 20 mL: 32 mmol, the mass fraction of the hydrochloric acid solution is 1%, and the amount ratio of boric acid group, the modifier and DMF on the pre-treated chitosan is 1 mmol: 1.2 mmol: 10 mL.
Comparative Example 1: compared with Embodiment 1, no modified monomer is added, and the remaining steps are the same.

Comparative Example 2 compared with Embodiment 1, no 2-Methacryloxyethyltrimethylammonium chloride is added, and the remaining steps are the same.
Comparative Example 3: compared with Embodiment 1, no hexafluorobutyl methacrylate is added, and the remaining steps are the same.

Comparative Example 4, compared with Embodiment 1, the modified filler is replaced by chitosan, and the remaining steps are the same.

The PBAT foamed materials prepared by Embodiments 1-3 and Comparative Examples 1˜4 are tested for their bactericidal rates against Staphylococcus aureus and Escherichia coli according to the standard QB/T2591-2003A. The test results are shown in Table 1.

TABLE 1
Bactericidal rate test data

| | | | | Com. | Com. | Com. | Com. |
|---|---|---|---|---|---|---|---|
| | Embodiment | Embodiment | Embodiment | Example | Example | Example | Example |
| | 1 | 2 | 3 | 1 | 2 | 3 | 4 |
| Staphylococcus | 99.92 | 99.96 | 99.98 | 81.74 | 93.17 | 89.61 | 85.94 |
| aureus | | | | | | | |
| sterilization | | | | | | | |
| rate % | | | | | | | |
| Escherichia | 99.93 | 99.95 | 99.96 | 82.21 | 93.52 | 90.08 | 86.23 |
| coli | | | | | | | |
| sterilization | | | | | | | |
| rate % | | | | | | | |

As can be seen from Table 1, the antibacterial PBAT foamed materials prepared in Embodiments 1-3 have a sterilization rate of 99.92-99.98% against Staphylococcus aureus and a sterilization rate of 99.93-99.96% against Escherichia coli. The Comparative Example 1 has a sterilization rate of 81.74% against Staphylococcus aureus and a sterilization rate of 82.21% against Escherichia coli. The Comparative Example 2 has a sterilization of 93.17% against Staphylococcus aureus and a sterilization of 93.52% against Escherichia coli. The Comparative Example 3 has a sterilization rate of 89.61% against Staphylococcus aureus and a sterilization rate of 90.08% against Escherichia coli. The Comparative Example 4 has a sterilization of 85.94% against Staphylococcus aureus and a sterilization of 86.23% against Escherichia coli. The above data indicates that the present disclosure achieves a very good antibacterial effect.

The above content is only examples and illustration of the concept of the present disclosure. Those skilled in the art may make various modifications or additions to the specific embodiments described or use similar alternatives, as long as they do not depart from the concept of the present disclosure or exceed the scope defined by the claims, all of which shall fall within the scope of the present disclosure.

What is claimed is:

1. A method for preparing an antibacterial PBAT foamed material, comprising:
Step A1: mixing 5,5-bis(hydroxymethyl)-2-phenyl-1,3-dioxane, sodium hydroxide, and DMF; stirring and adding 3-bromo-1-propene for reaction to obtain intermediate 1; mixing the intermediate 1 with a hydrochloric acid solution and DMF for reaction to obtain intermediate 2;
Step A2: mixing the intermediate 2, 2-methacryloxyethyltrimethylammonium chloride, hexafluorobutyl methacrylate, and DMF; stirring and adding ammonium persulfate for reaction to obtain a modified monomer; mixing the modified monomer, terephthalic acid, adipic acid, 1,4-butanediol, tetrabutyl titanate, antimony trioxide, and N-methylpyrrolidone for reaction; raising temperature for reaction to obtain a modified copolymer; and
Step A3: melting and kneading the modified copolymer, a modified filler, and azodicarbonamide; foaming under a stabilized pressure; cooling to room temperature, soaking in a treatment solution under a stabilized temperature to obtain a resultant; taking out the resultant and drying to obtain the antibacterial PBAT foamed material;
wherein in the Step A1, an amount ratio of 5,5-bis(hydroxymethyl)-2-phenyl-1,3-dioxane, sodium hydroxide, 3-bromo-1-propene, and DMF is 1 mmol: 1.1 mmol: 1 mmol: 10 mL;
a preparation process of the modified filler comprises:
Step B1: mixing p-bromobenzaldehyde, 1,10-phenanthroline-5,6-dione, ammonium acetate, and acetic acid for reaction; adding ammonia water to neutralize to obtain intermediate 3; mixing triisopropyl borate, n-butyllithium, and tetrahydrofuran, and stirring and adding the intermediate 3 for reaction to obtain a modifier; and
Step B2: dissolving chitosan in a hydrochloric acid solution, adding caffeic acid, deionized water, and anhydrous ethanol; stirring and adding 1-ethyl-3-(3-dimethylaminopropyl) carbodiimide for reaction to obtain pre-treated chitosan; mixing the pre-treated chitosan, the modifier, and DMF, and stirring and adding tetramethylammonium hydroxide for reaction to obtain the modified filler.

2. The method according to claim 1, wherein in the Step A1, an amount ratio of the intermediate 1, hydrochloric acid solution, and DMF is 2 mmol: 3 mL: 10 mL.

3. The method according to claim 1, wherein in the step A2, an amount ratio of the intermediate 2, 2-methacryloxyethyltrimethylammonium chloride, hexafluorobutyl methacrylate, and DMF is 2.5 g: 13.8 g: 18.2 g: 100 mL; an amount ratio of the modified monomer, terephthalic acid, adipic acid, 1,4-butanediol, and N-methylpyrrolidone is 157 g: 996 g: 584 g: 900 g: 10 L.

4. The method according to claim 1, wherein in the Step A3, a mass ratio of the modified copolymer, modified filler, and azodicarbonamide is (80-100):(3-5):(2-3), and the treatment solution is a 0.1 mmol/L solution of ruthenium dichloride in ethanol.

5. The method according to claim 1, wherein in the Step B1, an amount ratio of p-bromobenzaldehyde, 1,10-phenanthroline-5,6-dione, ammonium acetate, and acetic acid is 2.5 mmol: 2.5 mmol: 4.8 g: 40 mL; an amount ratio of triisopropyl borate, n-butyllithium, the intermediate 3, and tetrahydrofuran is 1 mmol: 2 mmol: 2 mmol: 10 mL.

6. The method according to claim 1, wherein in the Step B2, an amount ratio of chitosan, the hydrochloric acid solution, caffeic acid, deionized water, anhydrous ethanol, and 1-ethyl-3-(3-dimethylaminopropyl) carbodiimide is 2 g: 200 mL: 15 mmol: 5 mL: 20 mL: 32 mmol.
